(19) United States
(12) Patent Application Publication
(10) Pub. No.: US 2017/0007859 A1
(43) Pub. Date: Jan. 12, 2017

(54) GAS PRESSURE REDUCER WITH ELECTRICALLY-POWERED MASTER SYSTEM

(71) Applicant: ZODIAC AEROTECHNICS, Plaisir (FR)

(72) Inventor: Matthieu Fromage, Saint-Arnoult-en-Yvelines (FR)

(21) Appl. No.: 15/119,148

(22) PCT Filed: Feb. 26, 2014
(86) PCT No.: PCT/IB2014/000372

§ 371 Date: Aug. 16, 2016

(51) Int. Cl. A62B 7/14; A62B 18/10; A62B 9/02; A62B 18/02; G05D 16/06; G05D 16/20

(52) U.S. Cl. CPC A62B 7/14; G05D 16/0663; G05D 16/2086; A62B 9/02; A62B 18/02; A62B 18/10

(57) ABSTRACT

A gas pressure reducer (100) comprises a mobile element (2) arranged for driving a pressure regulating valve (5) according to a pressure force, a biasing element (3) for pushing the mobile element toward a rest position, and an electrically-powered master system which acts on the biasing element for varying a return force of said biasing element. The master system allows varying a reference pressure value for the regulation of the pressure existing at a low pressure gas outlet (1 LP). When the master system is no longer electrically supplied, the mobile element (2) is driven by the pressure force with respect to a last value of the return force existing just before electrical supply of said master system has stopped.

The invention relates to a gas pressure reducer, also called gas regulator, which comprises an electrically-powered master system.

### BACKGROUND OF THE INVENTION

A gas pressure reducer as known before the present invention commonly comprises:
a high pressure gas inlet,
a low pressure gas outlet,
a gas flow path which connects the high pressure gas inlet to the low pressure gas outlet, and comprises a valve,
a mobile element which is arranged for driving the valve so as to allow, limit or stop gas flow within the gas flow path depending on a position of this mobile element, and
a biasing element which is arranged for pushing the mobile element toward a rest position, according to a return force produced by this biasing element onto the mobile element.

The mobile element comprises a surface portion which is sensitive to the pressure which exists at the low pressure gas outlet, so as to produce a pressure force. When operating, this pressure force drives the mobile element out of the rest position when it becomes higher than the return force. The value of the return force thus determines the gas pressure at the low pressure gas outlet when no saturation occurs, in particular when no excessive gas leak occurs downstream the reducer. This gas pressure determined by the return force is commonly called reference pressure value. Such gas pressure reducer is known for example from WO 2007/054122, in particular FIG. 3.1 of this document.

It is also known completing such gas pressure reducer with an electrically-powered master system which is arranged for acting on the biasing element so as to vary the return force. The reference pressure value can thus be varied either by an operator or automatically, according to an open-loop or closed-loop control mode.

But an issue appears when electrical failure occurs, due to the master system being electrically powered. Indeed, a stop in the operation of the master system due to the electrical failure may inhibit the operation of the whole gas pressure reducer, and even of an entire gas delivery system which includes the gas pressure reducer. Such operation failure may be unacceptable for some applications of the system, in particular applications to aircrafts where operation continuation is a major issue.

In addition, some applications require gas delivery systems which can be easily controlled for producing a desired pressure value or a desired flow value at output. Such value control may be requested to be implemented remotely, without direct access to the gas pressure reducer for an operator.

Then objects of the present invention consist in providing a new gas pressure reducer which solves at least one of these issues, or provides improvement over known devices.

### SUMMARY OF THE INVENTION

For meeting these objects or others, a first aspect of the invention proposes a gas pressure reducer with components and operation as indicated above, including the electrically-powered master system. According to the invention, the master system is arranged so that when it is no longer electrically supplied, the mobile element is continually driven by the pressure force with respect to a last value of the return force which was existing just before the electrical supply of the master system has stopped. So, the operation where the return force remains constant forms a secure operation mode, which is efficient upon electrical failure. In addition such secure operation is automatically effective upon occurrence of an electrical failure without any action from an operator or any external actuator, and whatever the actual value of the return force.

Furthermore, the master system allows varying easily the pressure at the gas outlet. Indeed, the master system sets the reference value for the pressure at this gas outlet, and the valve driven by the mobile element due to the pressure force regulates the pressure which actually exists at the gas outlet to this reference value.

In preferred embodiments of the invention, the master system may be arranged for moving at least part of the biasing element when being electrically supplied, and this biasing element part remains in a constant position whatever the pressure force once the master system has stopped being electrically supplied. This constant position of the biasing element part since the stop of the electrical supply is that produced last by the master system. More preferably, the master system may be arranged so that the biasing element is unable of transmitting motion back to the master system. Such motion transmission is said to be irreversible.

In possible embodiments, the master system may comprise a motor designed for producing a rotation when this motor is electrically supplied, and also an intermediate transmission system which is adapted for converting the rotation produced by the motor into a change in the position of the biasing element part. In particular, the motor may be of a piezoelectric type. In case of electrical failure, the motor position remains constant and the valve operates continually for controlling the output pressure based on the reference value as set by the motor position.

Various embodiments of the invention may also combine advantageously one or several among the following improvements:
the master system may comprise a piezoelectric actuator, in particular a piezoelectric actuator suitable for producing a linear or rotary motion;
the biasing element may have two end parts which are opposed to each other, one of these end parts being arranged for pushing onto the mobile element, and the master system being arranged for moving the other end part of the biasing element when the master system is electrically supplied;
the mobile element may comprise at least part of a diaphragm, or part of bellows, or part of a piston, which part forms the surface portion which is sensitive to the pressure existing at the low pressure gas outlet;
the gas pressure reducer may further comprise a position sensor which is arranged for sensing the position of the mobile element;
the master system may be adapted for acting on the biasing element according to a continuous control mode based on at least one control parameter, in particular a control mode of proportional type;
the gas pressure reducer may further comprise a feedback line which is suitable for providing a feedback signal to the master system. Such feedback signal may represent a parameter selected among the gas pressure existing at the low pressure gas outlet, the position of the mobile element, a speed of the mobile element, an electrical current implemented by the master system, a voltage implemented by the master system, a frequency implemented by the master system, a gas flow existing downstream the low pressure gas outlet, parameters relating to ambient conditions, or a combination of at least two of these parameters;
the master system may comprise a controller and an actuator, the actuator being dedicated for acting on the biasing element, and the controller being suitable for controlling an operation of the actuator according to the continuous control mode. In particular, the actuator may be the motor above-indicated; and
the rest position for the mobile element may correspond to the valve allowing maximum gas flow from the high pressure gas inlet to the low pressure gas outlet, and the pressure force acts on the mobile element so that the valve limits or stops the gas flow.

A second aspect of the invention proposes a gas delivery system which comprises at least one gas pressure reducer according to the first invention aspect, and also comprises a high pressure source of gas which is connected to the high pressure gas inlet of the gas pressure reducer, and at least one end-equipment which is connected to the low pressure gas outlet of the gas pressure reducer. In such system, the gas pressure reducer is adapted for regulating the pressure existing at the low pressure gas outlet to a reference pressure value.

Such gas delivery system may be an oxygen delivery system for aircraft, which is suitable for delivering an oxygen-containing gas to at least one end-user within the aircraft, such as a crew member or a passenger. To this end, the high pressure source supplies an oxygen-containing gas, and each end-equipment is one respective end-user equipment. Possibly, when such oxygen delivery system is of decentralized type, it may comprise several end-user equipments connected to the low pressure gas outlet of the gas pressure reducer through respective gas-delivering paths. Each gas-delivering path may comprise a calibrated orifice which is suitable for converting the reference pressure value into a reference flow value for a gas quantity which is delivered at the corresponding end-user equipment. Alternatively, each end-user equipment may be a respective crew mask regulator. For such applications, the reference pressure value may vary as a function of an ambient pressure existing within the aircraft.

Alternatively, the gas delivery system may be a gas management system which is suitable for delivering an oxygen- or hydrogen-containing gas to a fuel cell. For such application, the high pressure source supplies at least one among an oxygen-containing gas or a hydrogen-containing gas.

These and other features of the invention will be now described with reference to the appended figures, which relate to preferred but not-limiting embodiments of the invention.

### BRIEF DESCRIPTION OF THE DRAWINGS

FIGS. 1a and 1b are cross-sectional views of part a gas pressure reducer according to one invention embodiment, respectively for two operating states of the gas pressure reducer;

FIG. 2 illustrates schematically the whole gas pressure reducer of FIGS. 1a and 1b; and

FIG. 3 is a block diagram of an oxygen delivery system for aircraft, which implements a gas pressure reducer according to the invention.

For clarity sake, element sizes which appear in these figures do not correspond to actual dimensions or dimension ratios. Also, same reference numbers which are indicated in different ones of these figures denote identical elements of elements with identical function. In addition, although some of the figures show the represented elements in detail, the description is limited to those of these elements which are involved in the invention. The other elements, not described, are not directly related to the invention, and their use and implementation is not modified significantly with respect to the knowledge common in the art, or is modified in an obvious extent. Words as “upper”, “lower”, “upwards” or “downwards” used hereafter refer to directions oriented as appearing in the figures.

### DETAILED DESCRIPTION OF THE INVENTION

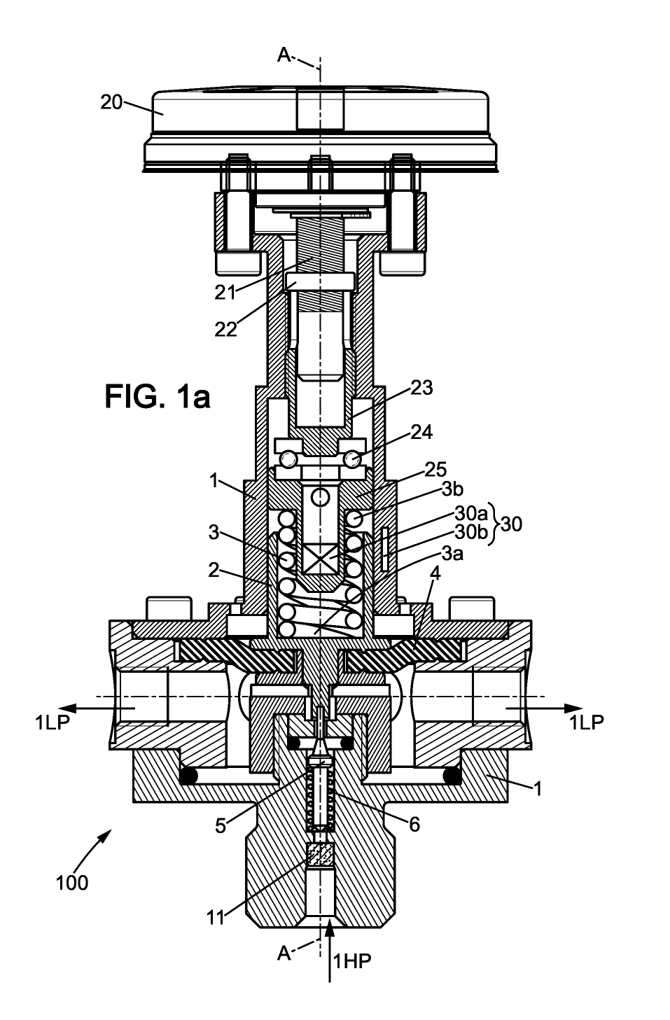

The following references are common to FIGS. 1a and 1b, and have the meanings now recited:
100 gas pressure reducer globally
A-A longitudinal axis of the gas pressure reducer
1 casing of the gas pressure reducer
1HP high pressure gas inlet of the gas pressure reducer
1LP low pressure gas outlet of the gas pressure reducer
2 mobile element
3 biasing element, possibly comprised of a spring
3a lower end part of the biasing element
3b upper end part of the biasing element
4 diaphragm
5 valve
11 filter, for example sintered filter

The casing 1 and possibly also the mobile element 2 may each be multipart, in particular for machining issues and for assembling of the whole gas pressure reducer.

The pressure value at the gas inlet 1HP may be initially about 200 bars, and the value at the gas outlet 1LP may be between external ambient pressure and 10 bars. Generally, the pressure at the gas inlet 1HP may be any value provided it is higher than the pressure at the gas outlet 1LP. In particular, the invention allows fine pressure regulation at the gas outlet 1LP, including for pressure around 2 mbars (millibar) at the low pressure gas outlet 1LP, even when the pressure at the high pressure gas inlet is around 2000 times higher than the outlet pressure.

In the embodiment described, the diaphragm 4 is connected hermetically to both the casing 1 and the mobile element 2, and forms part of a wall defining the gas flow path within the gas pressure reducer 100. The mobile element 2 may be adapted for sliding within the casing 1 so as to drive the valve 5 into either open position or closed position, or also possibly an intermediate position. The end portion 3a of the biasing element 3 pushes downwards onto the mobile element 2 so that the valve 5 is urged into open position, thereby allowing gas flow from the gas inlet 1HP to the gas outlet 1LP. This state has been denoted rest position for the mobile element 2 in the general part of this description, and may correspond to the mobile element 2 abutting against a stop portion of the casing 1 or against another element provided for this stop function. This rest position is ensured by a return force which is produced by the biasing element 3 onto the mobile element 2. In the embodiment described, this state also corresponds to maximum opening for the valve 5. The arrows near the labels 1HP and 1LP indicates the gas flow direction.

In the particular embodiment of FIGS. 1a and 1b, the valve 5 is comprised of a sliding plug which is provided with a conical segment. This conical segment is suitable for blocking gas flow through an aperture which arranged in the gas flow path. The biasing element 3 is a spring, and reference number 6 denotes a secondary spring which causes the valve 5 to follow the mobile element 2. When the gas pressure at the low pressure gas outlet 1LP rises so that the gas produces onto the diaphragm 4 a pressure force which becomes higher than the return force, then diaphragm 4 pushes the mobile element 2 upwards, and the valve 5 shifts to the closed position and stops the gas flow. This closed position remains until the pressure at the gas outlet 1LP decreases so that the pressure force is again lower than the return force. So the gas pressure at the outlet 1LP which corresponds to the pressure force equalling the return force appears as a reference value when considering pressure regulation. In particular, this reference value may be zero-pressure at the gas outlet 1LP, corresponding to no gas flowing from the gas outlet. Generally, the reference value equals at maximum the pressure which is supplied at the high pressure gas inlet 1HP, or is intermediate between this maximum pressure value and zero-pressure, possibly equalling zero or may also be negative corresponding to suction from outside at the gas outlet 1LP. Such operation is well known, so that it is not necessary to describe it further. FIG. 1a illustrates such gas pressure reducer with the valve 5 in open position, and FIG. 1b illustrates the same gas pressure reducer with the valve 5 in closed position.

The gas pressure reducer of FIGS. 1a and 1b has been completed with the following additional elements for implementing the invention:
20 motor
21 motor shaft
22 transverse pin
23 rotating intermediate element
24 balls
25 translating intermediate element

The motor 20 may be of any type, but a piezoelectric motor may be preferred for reduced volume, weight, reliability and energy consumption issues. It is electrically powered.

Elements 22 to 25 convert the rotating motion of the motor shaft 21 into a translation shift of the element 25. The motor shaft 21 drives in rotation the rotating intermediate element 23 due to the pin 22 which extends transversely through both the shaft 21 and the element 23. Because the element 23 is provided with a peripheral thread engaged with a correspond thread of the casing 1, it combines a rotational motion and a translation shift. The opening through the rotating intermediate element 23, which is dedicated to the arrangement of the pin 22, is elongated for not impeding the translation shift. The translation shift is only transmitted to the translating intermediate element 25 through the balls 24. For assembling purpose, the elongated opening in the rotating intermediate element 23 may extend up to the upper end of this element 23. Any other system suitable for converting the rotation of the motor 20 into a translation of the intermediate element 25 may be used alternatively.

The intermediate element 25 serves as a seat for the end part 3b of the biasing element 3. In this way, the translating intermediate element 25 allows changing the length of the spring 3, thereby changing the return force. As a consequence, the reference value for the regulated pressure at the gas outlet 1LP is modified.

When the motor 20 is no longer powered, then the position of the translating intermediate element 25 and the upper end part 3b of the biasing element 3 remains unchanged. But the pressure force goes on causing motion of the mobile element 2 so that the pressure at the gas outlet 1LP is still regulated pneumatically. This regulation is based on the return force which corresponds to the length of the biasing element 3 as existing since the stop of the electrical supply.

The gas pressure reducer 100 may optionally be provided with a position sensor 30, for measuring the instant position of the mobile element 2 along the longitudinal axis A-A. Preferably, the sensor 30 is contactless, possibly of magnetic type, in particular based on Hall effect. Such position sensors are well known and commercially available. They are commonly comprised of a first sensor part 30a to be fixedly incorporated into the mobile element 2, and a second sensor part 30b to be fixedly bounded to the casing 1. Such sensor 30 may be implemented as a built-in test device, suitable for checking the operation of the gas pressure reducer 100 after manufacturing or for in-situ acceptance test.

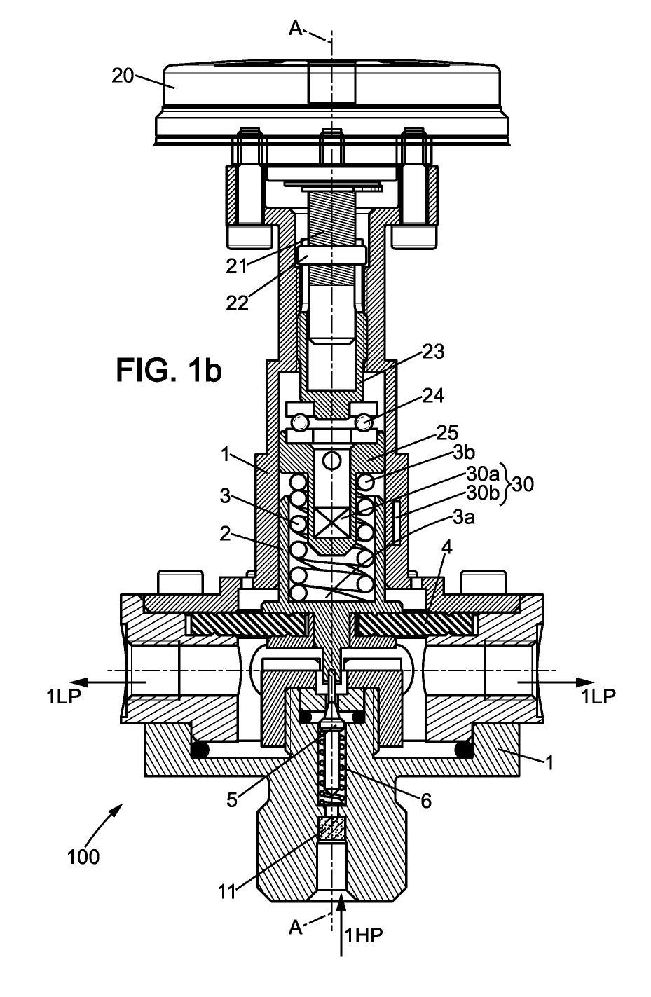

According to FIG. 2, the motor 20 may be part of a master system which further comprises a sensor 41 and a controller 42, denoted CTRL. The controller 42 is connected for controlling the operation of the motor 20, i.e. its rotation angle and also possibly rotation speed, based on a measurement signal which is provided by the sensor 41 and forms a control signal or feedback signal. Reference number 43 denotes generally the electrical supply connection to the motor 20, from the controller 42. For example, the sensor 41 may be a pressure sensor arranged at the low pressure gas outlet 1LP of the gas pressure reducer 100. Reference number 44 denotes a feedback line which extends from the sensor 41 to the controller 42. Other control parameters may be used by the controller 42 for controlling the motor 20, including the voltage and/or current and/or an activation frequency which is supplied to the motor 20, depending on the motor type. Control parameters not related directly to the gas flow or the electrical supply to the motor 20 may also be used, in combination with or instead of the parameters already cited. Such external control parameters may be inputted into the controller 42 at an extra input 45. Also possibly, the measurement signal which is outputted by the position sensor 30 may be used by the controller 42 for controlling the motor 20. Any of these control parameters allows automatic tuning of the reference value for the regulation of the pressure existing at the gas outlet 1LP. Control mode of proportional type, or possibly mixed proportional-integral type, is preferred for the present embodiment. Known feedback-control algorithms may be used advantageously within the controller 42 for obtaining a stable operation, without oscillation behaviour.

A major advantage which is provided by using the pressure existing at the gas outlet 1LP as a feedback parameter is to compensate automatically for hysteretic phenomena or effects of variations in the high pressure of the gas supply at the inlet 1HP. Indeed the diaphragm 4, sliding friction and seals possibly implemented in the gas pressure reducer 100 may cause important hysteresis which otherwise would impede accurate regulation of the pressure existing at the gas outlet 1LP. Variations of the high pressure value for the gas supply at the inlet 1HP may also alter the operation, in particular due to action of the high pressure onto the valve 5. Such interfering effects are all compensated for by implementing a closed-loop control mode within the gas pressure reducer 100, whatever the source of the interfering effect.

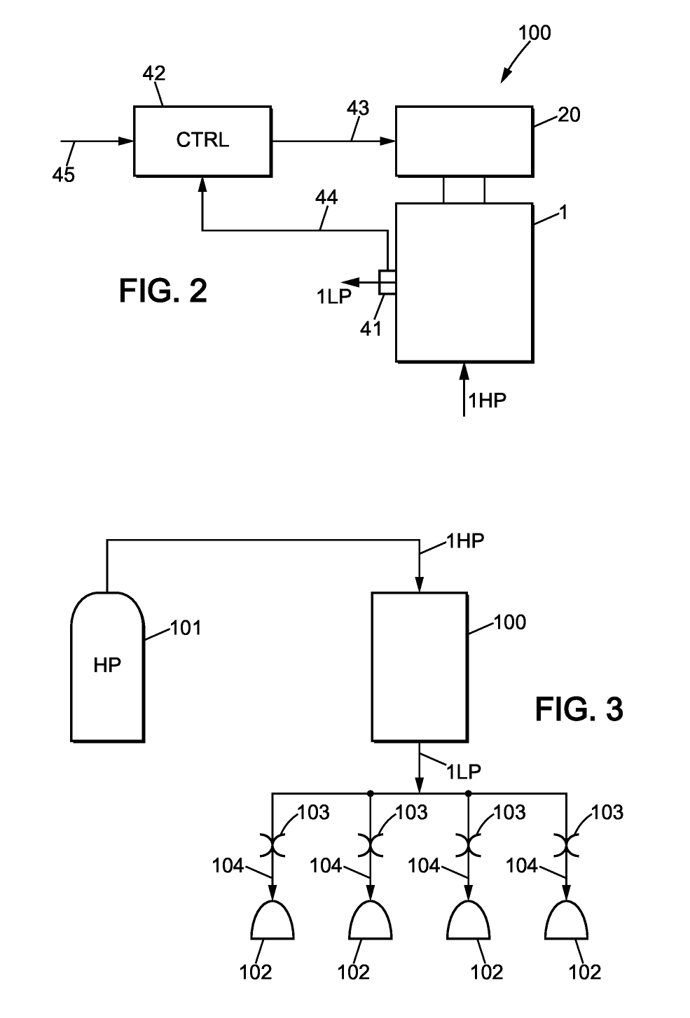

According to FIG. 3, a gas pressure reducer 100 according to the invention may be advantageously used in an oxygen delivery system suitable for an aircraft. Such system delivers an oxygen-containing gas from a high pressure gas source 101, denoted HP. The gas delivered may be pure oxygen or air, possibly depending on the system being intended to a crew member or passengers. The high pressure gas source 101 is connected to the gas inlet 1HP of the gas pressure reducer 100. When intended to passengers, a single gas pressure reducer 100 may be used for delivering low pressure gas to several end-user equipments 102, according to a so-called decentralized system structure. Each end-user equipment 102 may be a breathing mask which is dedicated to a separate passenger seat. When dedicated to a crew member, only one end-user equipment 102 may be connected to one and same gas pressure reducer 100. A calibrated orifice 103 may be arranged in the gas delivery line 104 which connects downstream one of the end-user equipments 102 to the outlet 1LP of the gas pressure reducer 100. The splitting of the gas delivery lines 104 and also the calibrated orifices 103 may be either integrated with the gas pressure reducer 100 at its low pressure gas outlet 1LP, or disposed outside the gas pressure reducer 100. When the gas pressure reducer 100 is operating for ensuring that the pressure existing at the gas outlet 1LP is close to the reference value, each calibrated orifice 103 converts this reference pressure value into a reference flow value for the oxygen-containing gas which is delivered at the corresponding end-user equipment 102. The reference pressure value or the reference flow value may be set as a function of the ambient pressure in the aircraft. A suitable pressure sensor may be used to this purpose, for feeding the controller 42 of the gas pressure reducer 100 with a control signal representative of the ambient pressure.

The Man skilled in the art will understand that gas pressure reducers according to the invention may be advantageously implemented for many applications in various fields, because of the easily-controlled and secure gas delivery which is obtained. Indeed, the control of such regulators is simple and can be adapted to the specifications of each application, without causing significant cost increase. As another application example, gas pressure reducers according to the invention may be used for properly and securely supplying gas to a fuel cell, in particular oxygen- or hydrogen-containing gas. Varying the reference pressure value remotely, without an operator acting physically on the gas pressure reducer itself, is of special interest for such fuel cell application.

One will understand that the invention embodiments which have been described in detail above may be adapted or modified about subsidiary aspects while maintaining at least some of the advantages cited. In particular, the biasing element may be multipart, that is comprised of several individual elements which act all together for producing the return force subject to variations controlled by the master system. In the embodiments described, the diaphragm may be replaced by bellows or a piston, according to equivalent designs which can be implemented without involving inventiveness. Also, the diaphragm may have both functions of producing the return force and sensing the pressure existing at the low pressure gas outlet. In such case, the biasing element and the part of the mobile element which is sensitive to the outlet gas pressure are combined.

Also invention embodiments with the master system being based on irreversible motion transmission systems other than that comprised of the elements 22 to 25 may be implemented alternatively. For example, the master system may be designed for pushing or pulling a tapered wedge perpendicular to the axis A-A, so as to shift the end part 3b of the biasing element 3 parallel to the axis A-A. In such embodiments, the master system may comprise a linear magnetic actuator, also called proportional coil, with actuating direction perpendicular to the motion direction of the mobile element 2. Master systems similar to that comprised of the elements 20 to 25 may also be used instead of such proportional coil.

Generally, and preferably for applications where gas saving is an issue, the rest position of the mobile element may correspond to the closed state of the valve, and the valve is then driven to open state by sufficient decrease in the pressure which actually exists at the low pressure gas outlet.

1. Gas pressure reducer comprising:
a high pressure gas inlet,
a low pressure gas outlet,
a gas flow path connecting the high pressure gas inlet to the low pressure gas outlet, and comprising a valve,
a mobile element arranged for driving the valve so as to allow, limit or stop gas flow within the gas flow path depending on a position of the mobile element,
a biasing element arranged for pushing the mobile element toward a rest position, according to a return force produced by said biasing element onto said mobile element, and
an electrically-powered master system arranged for acting on the biasing element so as to vary the return force,
wherein the mobile element comprises a surface portion sensitive to a gas pressure existing at the low pressure gas outlet so as to produce a pressure force, and the pressure force drives the mobile element out of the rest position when said pressure force becomes higher than the return force,
characterized in that the master system is arranged so that when said master system is no longer electrically supplied, the mobile element is continually driven by the pressure force with respect to a last value of the return force existing just before electrical supply of said master system has stopped.

2. Gas pressure reducer according to claim 1, wherein the master system is arranged for moving at least part of the biasing element when said master system is electrically supplied, and so that said part of the biasing element remains in a constant position whatever the pressure force once the master system has stopped being electrically supplied.

3. Gas pressure reducer according to claim 2, wherein the master system is arranged so that the biasing element is unable of transmitting motion to the master system.

4. Gas pressure reducer according to claim 2, wherein the master system comprises a piezoelectric actuator.

5. Gas pressure reducer according to claim 1, wherein the master system comprises a motor designed for producing a rotation when said motor is electrically supplied, and the master system further comprises an intermediate transmission system adapted for converting the rotation produced by the motor into a change in the position of the biasing element part.

6. Gas pressure reducer according to claim 5, wherein the motor is of a piezoelectric type.

7. Gas pressure reducer according to claim 1, wherein the biasing element has two end parts opposed to each other, one of said end parts being arranged for pushing onto the mobile element, and the master system being arranged for moving the other end part when said master system is electrically supplied.

8. Gas pressure reducer according to claim 1, wherein the mobile element comprises at least part of a diaphragm, or part of bellows, or part of a piston, and said part of the diaphragm, bellows or piston forms the surface portion which is sensitive to the pressure existing at the low pressure gas outlet.

9. Gas pressure reducer according to claim 1, further comprising a position sensor arranged for sensing the position of the mobile element.

10. Gas pressure reducer according to claim 1, wherein the master system is adapted for acting on the biasing element according to a continuous control mode based on at least one control parameter, in particular a control mode of proportional type.

11. Gas pressure reducer according to claim 1, further comprising a feedback line suitable for providing a feedback signal to the master system, said feedback signal representing a parameter selected among the gas pressure existing at the low pressure gas outlet, the position of the mobile element, a speed of the mobile element, an electrical current implemented by the master system, a voltage implemented by the master system, a frequency implemented by the master system, a gas flow existing downstream the low pressure gas outlet, parameters relating to ambient conditions, or a combination of at least two of said parameters.

12. Gas pressure reducer according to claim 10, wherein the master system comprises a controller and an actuator, the actuator being dedicated for acting on the biasing element, and the controller being suitable for controlling an operation of the actuator according to the continuous control mode.

13. Gas pressure reducer according to claim 1, wherein the rest position for the mobile element corresponds to the valve allowing maximum gas flow from the high pressure gas inlet to the low pressure gas outlet, and the pressure force acts on the mobile element so that the valve limits or stops the gas flow.

14. Gas delivery system comprising at least one gas pressure reducer according to claim 1, also comprising a high pressure source of gas connected to the high pressure gas inlet of the gas pressure reducer, and at least one end-equipment connected to the low pressure gas outlet of the gas pressure reducer, wherein the gas pressure reducer is adapted for regulating the pressure existing at the low pressure gas outlet to a reference pressure value.

15. Gas delivery system according to claim 14, forming an oxygen delivery system for aircraft, suitable for delivering an oxygen-containing gas to at least one end-user within the aircraft, wherein the high pressure source supplies an oxygen-containing gas, and the at least one end-equipment is the at least one end-user equipment.

16. Gas delivery system according to claim 15, comprising several end-user equipments connected to the low pressure gas outlet of the gas pressure reducer through respective gas-delivering paths, each gas-delivering path comprises a calibrated orifice suitable for converting the reference pressure value into a reference flow value for a gas quantity which is delivered at the corresponding end-user equipment.

17. Gas delivery system according to claim 15, wherein each end-user equipment is a crew mask regulator.

18. Gas delivery system according to claim 15, adapted so that the reference pressure value varies as a function of an ambient pressure existing within the aircraft.

19. Gas delivery system according to claim 14, forming a gas management system suitable for delivering an oxygen- or hydrogen-containing gas to a fuel cell, wherein the high pressure source supplies at least one among an oxygen-containing gas or a hydrogen-containing gas.
